(19) United States
(12) Patent Application Publication
(10) Pub. No.: US 2015/0324457 A1
(43) Pub. Date: Nov. 12, 2015

(54) Ordering a Set of Regular Expressions for Matching Against a String

(71) Applicant: Dell Products, LP, Round Rock, TX (US)

(72) Inventor: Lewis I. McLean, Edinburgh (GB)

(73) Assignee: Dell Products, LP, Round Rock, TX (US)

(21) Appl. No.: 14/274,058

(22) Filed: May 9, 2014

(51) Int. Cl. G06F 17/30

(52) U.S. Cl. CPC G06F 17/30684; G06F 17/30958

(57) ABSTRACT

An information handling system matches regular expressions by placing the regular expressions into parent/child relationships. A first regular expression is set as a child of a second regular expression when information about matching the first regular expression against a first string is obtained by matching the second regular expression against the first string. The information handling system forms the regular expressions into a graph. The regular expressions are matched against a second string in an order based upon a structure of the graph. A third regular expression is matched against the second string before a fourth regular expression based upon a vertex representing the fourth regular expression being a child of a vertex representing the third regular expression.

### FIELD OF THE DISCLOSURE

The present disclosure generally relates to information handling systems, and more particularly relates to matching a set of regular expressions against a string of characters.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination. An information handling system may match regular expressions against strings of characters.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a flow diagram illustrating a method of matching a set of regular expressions against a string according to an embodiment of the present disclosure;

FIG. 2 is a diagram illustrating a method of determining parent/child relationships between regular expressions according to an embodiment of the present disclosure;

FIG. 3 is a diagram illustrating a second method of determining parent/child relationships between regular expressions according to an embodiment of the present disclosure;

FIG. 4 is a diagram illustrating a third method of determining parent/child relationships between regular expressions according to an embodiment of the present disclosure;

FIG. 5 is a diagram illustrating a fourth method of determining parent/child relationships between regular expressions according to an embodiment of the present disclosure;

FIGS. 6 and 7 are diagrams illustrating a method of grouping regular expressions into a graph structure according to an embodiment of the present disclosure;

FIG. 8 is a block diagram illustrating an information handling system to place regular expressions in a graph annotated with information about matching strings according to an embodiment of the present disclosure; and

FIG. 9 is a block diagram illustrating an information handling system according to another embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

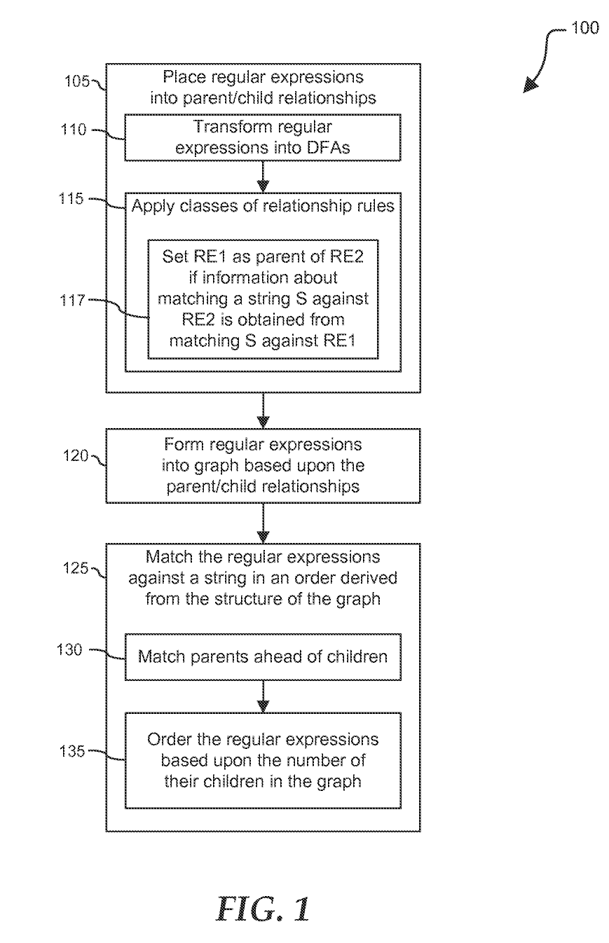

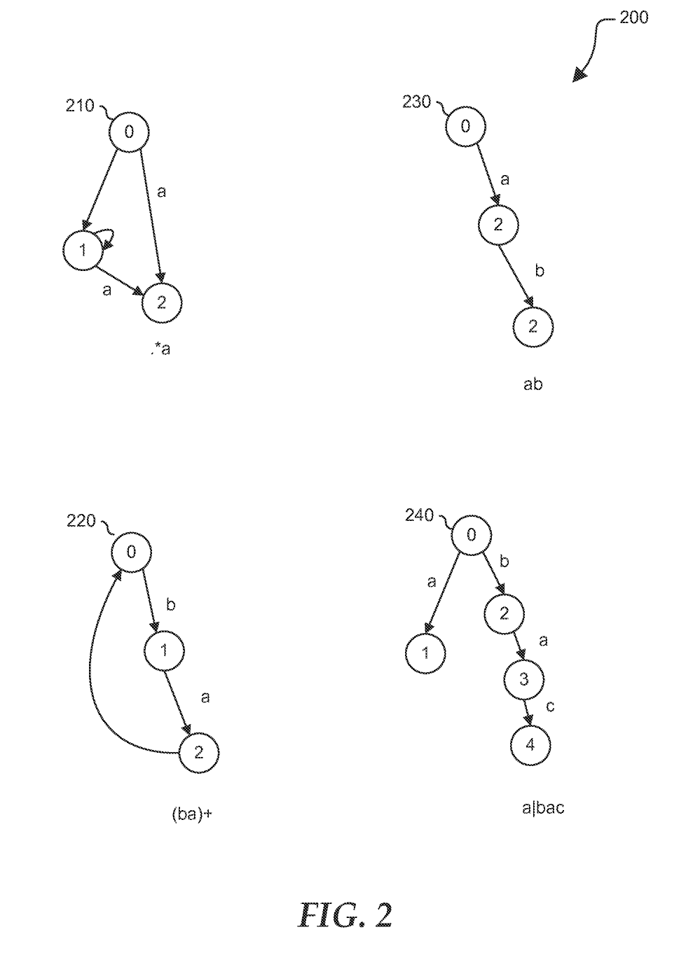

FIG. 1 shows a method 100 of ordering a set of regular expressions for matching against a string. The blocks of FIG. 1 will be discussed in connection with FIGS. 2-7. A regular expression (RE) is a description of a set of strings over an alphabet, such as but not exclusively the letters over the Roman alphabet. Other alphabets may, for example, include Unicode. In general, an alphabet may consist of a finite set of symbols.

Matching a string against an RE is determining whether the string is contained in the set of strings described by the RE. The string is said to match the RE if the string is contained in the set of strings described by the RE. Regular expressions over a finite alphabet Σ can be defined recursively as follows:
Constant Regular Expressions
   (empty set) Ø denoting the set Ø.
   (empty string) ε denoting the set containing only the empty string, which has no characters at all.
   (literal character) a in Σ denoting the set containing only the character a.
Recursion. Given regular expressions R and S, the following operations over them produce regular expressions:
   (concatenation) RS denotes the set of strings that can be obtained by concatenating a string in R and a string in S. For example, {“ab”, “c”} {“d”, “ef”}={“abd”, “abef”, “cd”, “cef”}
   (alternation) R|S denotes the set union of sets described by R and S. For example, if R describes {“ab”, “c”} and S describes {“ab”, “d”, “er”}, R|S denotes {“ab”, “c”, “d”, “ef”}.
   (Kleene star) R* denotes the set of all strings that can be made by concatenating any finite number (including zero) of strings from the set described by R. For example, {“0”,“1”}* is the set of all finite binary strings (including the empty string), and {“ab”, “c”} *={ε, “ab”, “c”, “abab”, “abc”, “cab”, “cc”, “ababab”, “abcab”, . . . }.
      In addition to the above symbols, other symbols that may be used in regular expressions include:
̂ Indicates the pattern must appear at the beginning of a string.
. Matches any character.
[ ] Bracket expression. Matches one of any characters enclosed.
[a b c] matches a, b, or c. The bracket expression is another way of describing alternation.
+Preceding item must occur 1 or more times.
[̂] Negates a bracket expression. The expression in the bracket matches any character except those enclosed. [̂ a b c] matches any character except a, b, or c. This use of the symbol “̂” is differentiated from its use above by the bracket. When the symbol appears within a bracket, it negates the bracket expression. When it appears outside a bracket, it denotes a requirement on the start of a string.

Method 100 begins at block 105 with placing regular expressions into parent/child relationships. Block 105 contains three sub-blocks. At block 110, the grouping may be implemented by transforming the regular expressions into deterministic finite automatas (DFAs). A DFA is a finite state machine that takes as input finite strings of symbols and outputs acceptance or rejection. A DFA may also output other information derived from the processing of strings. A DFA is deterministic in that repeated inputs of a string result in the same computation and same output. DFAs may be implemented as circuits or in software. DFAs may be represented by graphs, and the vertices and edges may represent portions of circuits or portions of programs. The basic procedure for such a transformation is as follows:
Transform the regular expressions into non-deterministic finite automatas (NFAs). Unlike a DFA, an NFA may transition to two or more states for a given state start and does not require an input symbol for a state transition.
Transform the NFAs into DFAs.

The basic rules for transformation of regular expressions (REs) into (NFAs) are as follows, where:
A character is represented by two vertices connected by an edge:

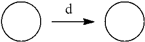

Concatenation of two REs is represented by placing an edge between the two: ab

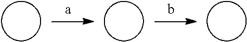

Alternation is represented by branches:
a|b

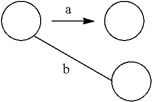

Kleene star is represented by a loop:

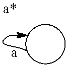

The basic rules for transformation of NFAs into DFAs are as follows:
Constructions other than * are unchanged.
Kleene star is expanded to represent the empty case as a separate vertex. In the simple case above, the transformation becomes:

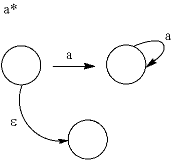

In more complicated cases, a subset construction algorithm may be used. The subset of vertices on an NFA that may be reached from a vertex on the NFA by empty transaction is transformed into a vertex on the corresponding DFA.

At block 115, classes of relationship rules can be applied to generate the parent/child relationships. The rules may be applied by graph traversal over each DFA within a set of DFAs representing the set of REs. The rules may be based upon information about the matching of one RE against a string that is obtained from attempting to match the string against another RE. The information may include whether or not the RE matched the string and A first RE, for example, may be placed in a parent/child relationship with a second RE if the first RE's matching a string implies that the second RE is a possible match and the first RE's not matching the string implies that the second RE is not a possible match. Similarly, the first RE may be placed in a parent/child relationship with the second if the first's matching a string implies the second is not a match and the first's not matching the string implies that the second is a possible match. More generally, information about the number of characters in the first RE matched by the string may provide information about the number of characters in the second RE matched by the string. The character match (CM) may be counted only for matches of characters explicitly specified in the RE. A match of the RE .*ab to the string zzzab, for example, returns CM=2, because the only characters explicitly listed in the RE that were part of the match were “a” and “b.” A CM value may be obtained during traversal of the RE by application of a modification of the Aho-Corasick algorithm.

In one embodiment, four classes of relationship rules may be applied, as illustrated by FIGS. 2-5. If one of the rules applies to two regular expressions, RE1 and RE2, then in block 117 a parent/child relationship between RE1 and RE2 is created. The relationship rules may be

### Rule 1:

RE1 is of the form.*<c> . . . , where <c> represents any character of an alphabet and ‘ . . . ’ represents that the remainder of the expression does not affect application of the rule. Thus, RE1 may begin with any substring other than <c>, but must contain the characters ‘<c> . . . ’ for a complete match.

RE2 is of one of the following forms:
.*<c> . . . . In this case, <c> is on a serial section (critical path) of RE2.
(<c><E>)* . . . where E represents any regular expression. In this case, <c> is on a cyclic, non-branched sequence of states.
(Pi1|P2| . . . Pn) where each path Pi is of the form .*<c> . . . . In this case, the character <c> is on is on all paths of a parallel divergence. As an example, RE2=[cb|ac|cd]. Each of the three alternate paths contains the character “c”.

Under Rule 1, if RE1 is known to match a string, then RE2 is a possible match for the string. The string must contain the character “c”, and containing the character “c” is a necessary but not sufficient condition for a string to match RE2. Conversely, if the attempt to match RE1 against a string returns that CM=0, then RE2 will not match the string, since the string does not contain the character “c”. In this case, by matching RE1 against the string first, the match of the string against RE2 is avoided, and the search for matches is rendered more efficient. Rule 1 can be generalized by replacing the character <c> with any constant expression, such as “abc.” The number of characters matched, provided by the CM value, may then indicate whether a match of the parent implies a match of the child.

Rule 1 is illustrated by FIG. 2. FIG. 2 is a diagram illustrating four DFAs representing regular expressions, RE210, RE220, RE230, and RE240. RE210 represents the regular expression.*a, which is of the form of RE1 in Rule 1. The diagram of RE210 illustrates that the DFA can form the string “a” by a transition from vertex 0 to vertex 2. The DFA can form the empty string by a transition from vertex 0 to vertex 1. Once at vertex 1, any number of characters can be added in a loop. Finally, the character “a” can be added in a transition from vertex 1 to vertex 2.
a. RE230 represents the regular expression ab, which is of the first of the forms of RE2 in Rule 1. The diagram shows the characters “a” and “b” added in two transitions. The character “a” from RE210 appears in a critical (sequential) section of RE230. RE220 represents the regular expression (ba)+ and is of the form of RE2 in part ii. of Rule 1. The diagram indicates that the string “ba” is created and then any number of additional copies may be concatenated in a loop. The character “a” from RE210 appears in the cyclic non-branched sequence of states (ba)+. RE230 represents the regular expression a|bac, and is of the form of RE2 in part iii. of Rule 1. The diagram shows a branch. The left branch forms the string “a”, while the right branch forms the string “bac”. Both branches of RE230, “a” and “bac”, contain the character “a”. Thus, under Rule 1, a parent/child relationship would be established between RE 210 as parent and each of REs 220, 230, and 240 as child.

If the constant term in the expression serving as RE1 in Rule 1 contained more than one character, the CM of RE1 and a string S may indicate whether a match of the RE1 and S implies a possible match of the child. Consider the following example:

| | |
|---|---|
| RE1 | .*abc |
| RE2 | a |
| RE3 | ab |
| RE4 | abc |

In this example, if CM>0 RE2 may match S. If CM=1, then neither RE3 nor RE4 will match S, because S did not contain the substring “ab”. If CM=2, then RE3 may match S, but RE4 will not match S. Thus, the CM of a match of RE1 against S may provide information about possible matches of RE2, RE3, and RE4 with S.

### Rule 2:

RE1 is of the form .*[<c1><c2> . . . <cN>] . . . . Thus, each string in the set of regular expressions represented by RE1 contains at least one of the N characters of the set C={c1, . . . , cN}.

RE2 is of one of the following forms:
<ci> . . . , where <ci> denotes one of the characters of C. In this case, <ci> is on a serial section (critical path) of RE2.
(<ci><E>)* . . . where E represents any regular expression. In this case, <ci> is on a cyclic, non-branched sequence of states of RE2.
(Pi1|Pi2| . . . Pik) where each path Pij is of the form.*<cij> . . . for cij in C. In this case, each of the paths of a parallel divergence contains a character of C. In a simple case, each of the parallel branches begins with a character of C. RE2 may then be written as
.*[<ci1><ci2><cik>] . . . where cij are characters in C; that is, RE2 contains a subset of the characters of C. As an example, RE1=[a b c d] and RE2=[a c d].

Under Rule 2, if an attempt to match RE1 against a string produces CM=0, then RE2 does not match the string. Rule 2 follows from Rule 1. Since CM=0, the string does not contain any of the characters of the C. Thus, the string cannot match any of the regular expressions of the form of RE2. Conversely, if RE1 is matches a string, then RE2 is a possible match.

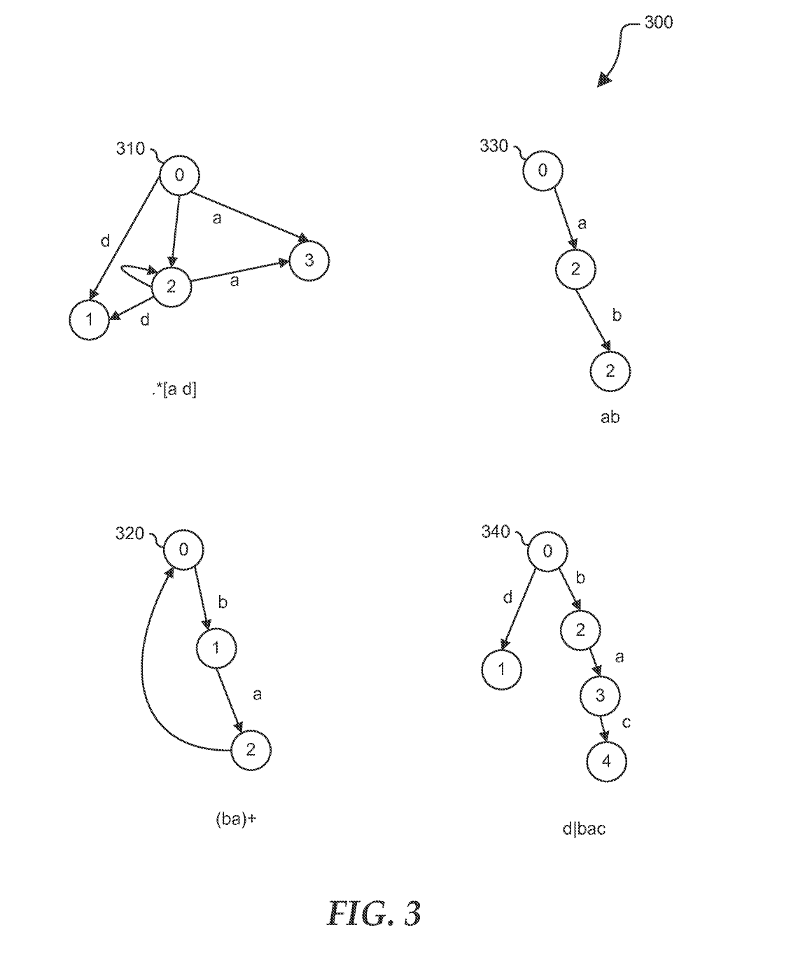

Rule 2 is illustrated by FIG. 3. FIG. 3 is a diagram illustrating four DFAs representing REs, RE310, RE320, RE330, and RE340. RE310 represents the regular expression .*[a d] and is of the form of RE1 in Rule 2. In this case, the character set C of possible alternates is the set {a d}.

RE330 represents the regular expression ab, and is of the first form of RE2 in Rule 2. The character “a” from set C appears in a critical (sequential) section of RE330. Thus, if an attempt to match RE310 against a string produces CM=0, the string contains neither the character “a” nor the character “d”. In particular, the string does not contain the character “a”. Thus, the string will not match RE330. RE320 is of the second form of RE2 in Rule 2. The character “a” from RE310 appears in the cyclic non-branched sequence of states (ba)+. Thus, if CM=0, the string will not match RE320.

RE340 represents the regular expression d|bac, and is of the form of RE2 in part iii. of Rule 2. Both branches of RE340 contain one of the characters of the set C. The string “d” contains the character “d” and the string “bac” contains the character “a”. Thus, if attempting to match RE310 against a string returns the result CM=0, the string will not match RE340.

### Rule 3:

RE1 is of the form [̂<c1><c2> . . . <cN>] . . . . Here, no string in the set of regular expressions represented by RE1 contains any of the N characters of the set C={c1, . . . , cN}.

RE2 is of one of the following forms:
<ci> . . . , where <ci> denotes one of the characters of the set C. In this case, <ci> is on a serial section (critical path) of RE2.
(<ci><E>)* . . . where E represents any regular expression. In this case, <ci> is on a cyclic, non-branched sequence of states of RE2.
(Pi1|Pi2| . . . Pik) . . . where each path Pij is of the form <cij> . . . for cij in C. In this case, each of the paths of a parallel divergence contains a character of C. In a simple case, each of the parallel branches begins with a character of C. RE2 may then be written as [<ci1><ci2> . . . <cik>] . . . where cij are characters in C. That is, RE2 contains a subset of the characters of S. As an example, RE1=[̂a b c d] and RE2=[a c d].
[̂<ci1><ci2> . . . <cik>] for cij in C.

When RE2 is one of the first three forms, if RE1 is known to match a string, then RE2 does not match the string. Since RE1 matches the string, the string does not contain any of the characters of the set C. Thus, the string cannot match any of the regular expressions of the form of RE2. Conversely, if RE1 does not match a string, then RE2 is a possible match. When RE2 is the fourth form, if RE1 matches a string, then the string does not contain any of the characters of the set C, so that RE2 may match the string. Conversely, if RE1 does not match the string, then the fourth formulation of RE2 may not match the string.

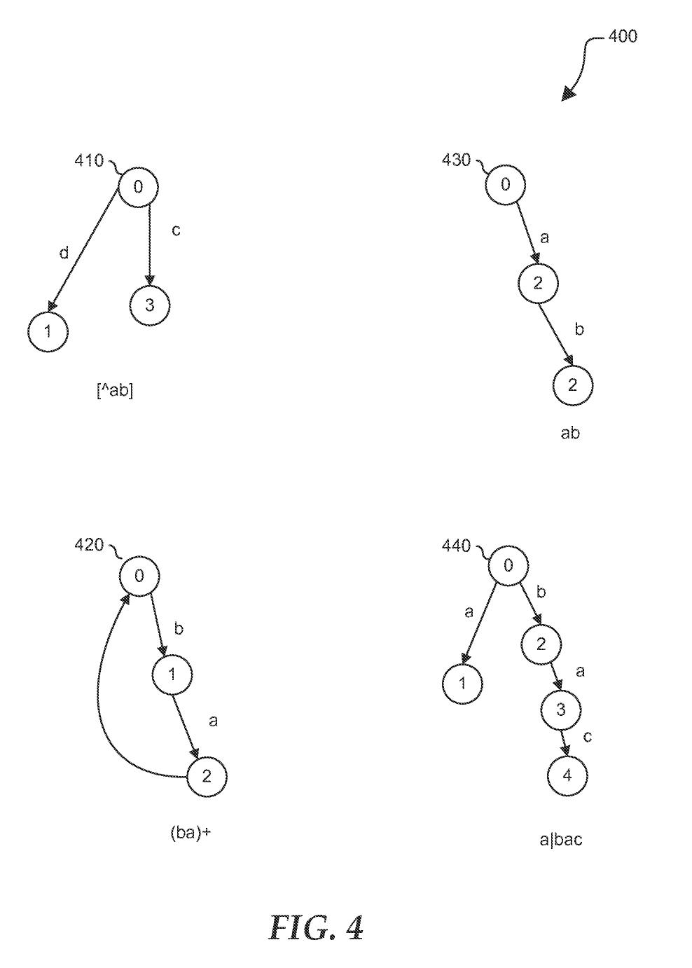

Rule 3 is illustrated by FIG. 4. FIG. 4 is a diagram illustrating four DFAs representing REs, RE410, RE420, RE430, and RE440. RE410 represents the regular expression [̂ab] and is of the form of RE1 in Rule 3. This expression denotes any character of an alphabet except the character “a” and the character “b”. For ease of illustration, the alphabet used in FIG. 4 consists of only four characters, “a”, “b”, “c”, and “d”. Thus, the notation [̂ab] represents the characters “c” and “d”. For this alphabet, the notation [̂ab] and the notation [cd] are equivalent.

RE430 represents the regular expression ab, and is of the first form of RE2 in Rule 3. The character “a” appears in a critical (sequential) section of RE430. Thus, if RE410 matches a string, the string does not contain the character “a” and will not match RE430. RE430 is of the form of RE2 in part ii. of Rule 3. The character “a” from RE410 appears in the cyclic non-branched sequence of states (ba)+. Thus, if RE410 matches a string, the string does not contain the character “a” and will not match RE430. RE440 represents the regular expression a|bac, and is of the third form of RE2 in Rule 3. Both branches of RE430, “a” and “bac” contain the character “a”. Thus, if RE410 matches a string, the string does not contain the character “a” and will not match RE440.

### Rule 4:

RE1 is of the form A<seq1> . . . ; where <seq> designates the N characters c1 through cN of an alphabet.

RE2 is of the form A<seq2> . . . ; where <seq2> designates the k characters d1 through dk of the alphabet of RE1.

Given RE1 and RE2 of the above forms, then determine the position M at which they first differ. If RE1 matches a string S up to t characters (CM for the match is t), then RE2 is not a match for S if t>=M, because S matches RE1 at a point where it diverges from RE2. Similarly, if CM<M−1, then RE2 is not a possible match for S, because it diverges from RE1 at a place where RE1 agrees with RE2. If, however, CM=M−1, then RE2 is a possible match for S.

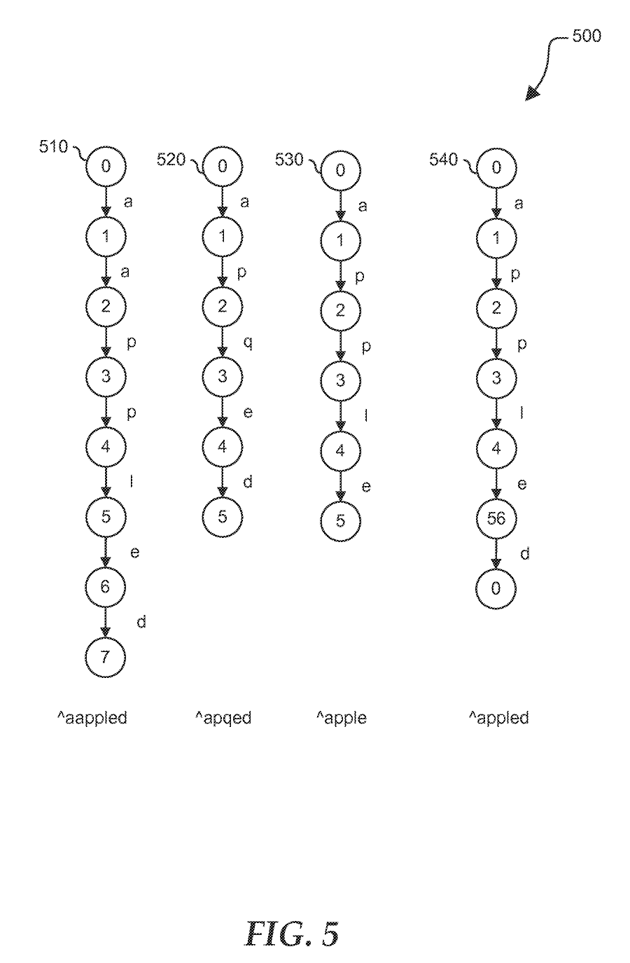

Rule 4 is illustrated by FIG. 5. FIG. 5 is a diagram illustrating DFAs representing four REs, RE510, RE520, RE530, and RE540. RE510 represents the regular expression ̂aapled, and is of the form of RE1 in Rule 4. RE520 represents the regular expression ̂apqed. RE510 and RE520 match at the first position, but differ in the second. If RE510 matches a string and CM=1, then the string is a possible match for RE520. If CM=0, the string cannot match RE520, because the first character is not “a”. Similarly, if CM>=2, the string cannot match RE520, because the second character of the string is “a” by the string's match with RE510. Similar statements may be made about RE510 and RE530, and RE510 and RE540. Rule 4 may also be applied to RE530 as RE1 and RE540 as RE2. In this case, if RE530 matches a string and CM is 5, then the string is a possible match for RE540. If CM<5, then the string is not a possible match.

In other embodiments, other rules for creating parent/child relationships may be used. Any rule for which information about a match of a string to one regular expression provides information about the match of the string to another regular expression may be used.

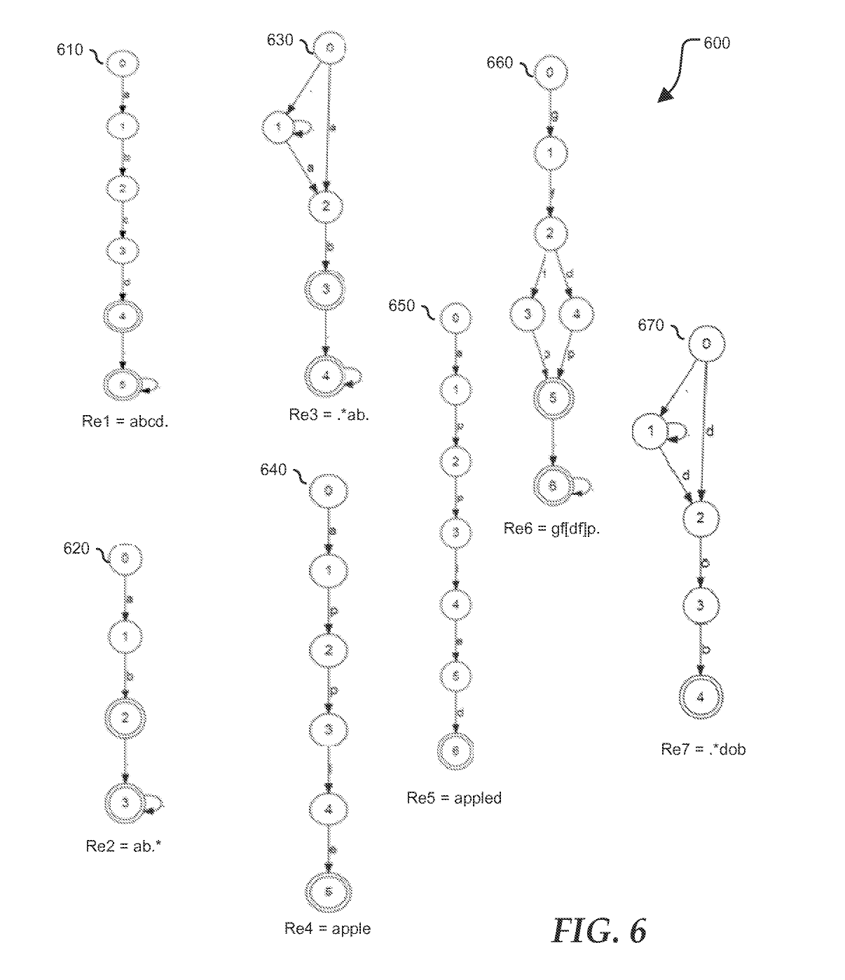

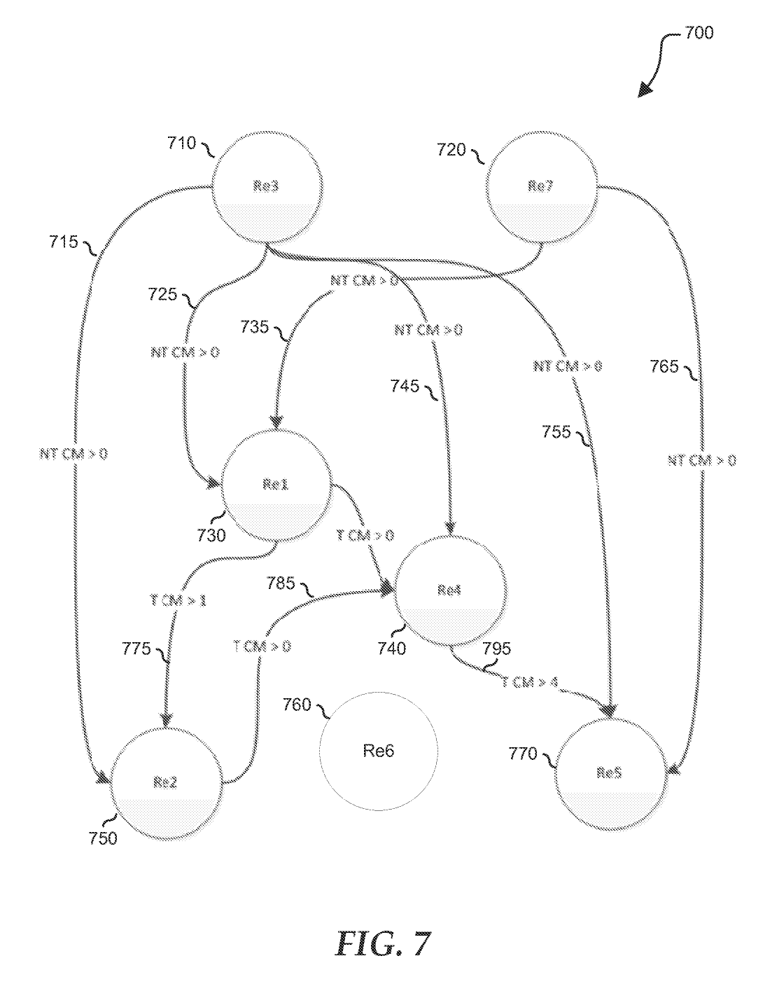

Returning to FIG. 1, in block 120, a graph is formed from the REs based upon the parent/child relationships. FIGS. 6 and 7 are diagrams illustrating a method of grouping regular expressions into a graph structure. FIG. 6 illustrates DFAs representing seven regular expressions:

| Designation | Expression |
|---|---|
| RE1 | \hat{ }abcd.* |
| RE2 | \hat{ }ab.* |
| RE3 | \hat{ }.*ab.* |
| RE4 | \hat{ }Apple |
| RE5 | \hat{ }Appled |
| RE6 | \hat{ }gf[df]p.* |
| RE7 | \hat{ }.*dob |

FIG. 7 illustrates the results of forming a graph from the regular expressions based upon the classes of rules. FIG. 7 contains vertices 710, 720, 730, 740, 750, 760, and 760, representing the regular expressions RE3, RE7, RE1, RE4, RE2, RE6, AND RE5, respectively and edges 715, 725, 735, 745, 755, 765, 775, 785, and 795. The edges indicate parent/child relationships between the vertex at the beginning of the edge and the vertex at the end of the edge. In FIG. 7, edge 715 connects RE3 and RE2, edge 725 connects RE3 and RE1, edge 735 connects RE7 and RE1, edge 745 connects RE3 and RE4, edge 755 connects RE3 and RE5, edge 765 connects RE7 and RE5, edge 775 connects RE1 and RE2, edge 785 connects RE2 and RE4, and edge 795 connects RE4 and RE5. The edges are annotated to indicate whether the parent/child relationship is transitive (the notation “T” or “NT”) and the value of a relevant CM indicator. The edges and the annotations are created by application of Rules 1-4 above. The rules may be applied by converting the regular expressions into DFAs and using graph traversal over each DFA.

The CM value on an edge between a parent vertex and a child vertex may indicate a constraint on a parent/child relationship. A comparison of the CM of a match of the parent to a string to the indicated CM value may indicate whether the child will match the string. A relationship □ is transitive if x □ y AND y □ z imply x □ z.

RE3 and RE7 meet the condition of the parent RE of rule 1, that it beings with .*. Application of Rule 1 produces the following relationships:

Re3→Re1,Re2,Re4,Re5

Re7→Re1,Re5

Note that RE7 is not a parent of RE6 under Rule 1, because one branch of the alternation of RE6 is “f”, which does not match the character “d” of RE7 following the .* syntax.

Rules 2 and 3 do not apply to the REs of FIG. 6. To apply Rule 4, compare two REs to determine the length of the initial substring on which they match. That length then constrains the parent/child relationship between the REs. For example, RE4 and RE5 begin with the same 5 characters. Therefore, if CM<5 for a match between RE4 and a string, the string cannot match RE5. Application of Rule 4 produces the following relationships:

Re4→Re5CM>4

Re1→Re2CM>1

Re1→Re4CM>0

Re2→Re4CM>0

After the parent/child relationships and annotations are formed by application of Rules 1-4, the vertices are then compiled together to form a graph. The relationships created by Rule 1 are all non-transitive and the CM requirement is CM>0. Edges created by Rule 4 may be transitive and the CM requirement is that CM>n−1, where n is the length of the initial substring on which the two REs match. Two edges created by Rule 4 may be transitive if the CM value does not decrease. Thus, the relationship

Re1→Re4→Re5

is transitive, because the CM value increases from 0 to 4. On the other hand, the relationship

Re1→Re2→Re4

is not transitive, because the CM value decreases from 1 to 0.

There are no edges between RE6 and any other REs, since RE6 is not involved in a parent/child relationship with any of the other REs of the set. Accordingly, RE6 may require separate processing. In the example of the creation of the graph of FIG. 7, all parent/child relationships are explicitly represented on the graph. Thus, for example, graph 700 depicts each relationship in the chain of relationships Re3→Re1→Re4→Re5, and also depicts the relationships Re3→Re4 and Re3→Re5. In other embodiments, a graph may omit a parent/child link between a parent and child RE when the graph depicts of chain of links leading from the parent RE to the child RE.

The process of compiling a set of REs into a graph does not need to be repeated each time the REs are matched against a set of strings. As long as the set of REs remains the same, the graph compiled from them can be reused. Further, most of the structure of a graph may be reused with the addition or subtraction of a few REs represented by vertices. When a graph depicts all relationships, then adding a vertex may be done by checking for parent/child relationships with the other vertices and adding links representing parent/child relationships as necessary. Similarly, when a vertex is deleted, its links with other vertices are removed. If the graph omits relationships that are derivable from chains of relationships, then the process of adding a vertex must examine the chains of relationships. When adding a new vertex N, for example, if both P1 and P2 are parents of N, then before adding both the links P1→N and P2→N a check must be performed if there is a parent/child relationship between P1 and P2. If so, then one of the two links may be omitted. Similarly, when deleting a vertex, it may be necessary to restore a link between two remaining vertices.

Returning to FIG. 1, at block 125, the REs are matched against a string in an order derived from the structure of the graph. The process may be illustrated in connection with the graph of FIG. 7, which may be used to order the matching of REs against strings. At block 130, when a parent vertex is a parent of a child vertex, a traversal of the graph matches the RE represented by the parent vertex against a string before matching the RE represented by the child vertex against the string.

In one procedure for using the structure of a graph generated from the parent/child relationships to order matching of REs, the next RE to be matched may be selected according to the following procedure:
select the set of REs in the graph structure that have not yet been matched
select from this set the subset of vertices that are not a child vertex of another vertex of the set.
select an RE from this subset.

At block 135, the RE selected may be an RE with a maximum number of children in the subset. In other embodiments, the order of REs may follow different rules. In some embodiments, for example, Rule 4 parent/child relationships may be given priority over parent/child relationships from other rules. As an example of an ordering rule involving Rule 4, when there is a set of REs of possible Rule 4 parents with common initial segments, choose as the parent one of the REs with the shortest initial segment. This choice of parent may minimize the cost of traversal of the RE. In the example of FIG. 5, REs 510, 520, 530, and 540 have common initial segments “a”, “ap”, and “app”. By this example rule, select RE520, ̂apqed or RE530, ̂apple, as the parent. RE520 (or 530) is the least complex (smallest) RE. Therefore, choosing this RE as a root and ordering the sub-tree as

520->[cm2]->530->[cm3]->540->[cm1]->510

might be beneficial in terms of execution cost vs non-match benefits.

The ordering of matching REs to match parent vertices ahead of child vertices may increase efficiency. The matching of a parent vertex against a string may obviate the matching of the child vertex against the string. The failure to match the parent may demonstrate that the child vertex will also fail to match, or the matching of the parent may demonstrate that the child vertex will also match. Conversely, in some cases, the matching of the parent vertex may indicate that the child vertex will fail to match the string. In many cases, the information provided by the CM of the match may indicate whether a child vertex can match. Thus, for example, if an attempt to match a string against RE4 produces a CM<4, then it is known that an attempt to match RE5 against the string will fail. An experiment in a system to detect malicious events containing a class of over 200,000 REs suggests that matching time may be halved in many cases from eliminating the need for matches of children.

The use of the structure of the graph may not produce a unique execution path for matching REs against strings. The structure may contain multiple vertices which are not child vertices of any other vertex. In FIG. 7, for example, any of RE3, RE7, and RE6 may be matched first, since none of these vertices are child vertices. As between vertices RE1, RE2, RE4, and RE5, however, the proper order of traversal is as listed. The other vertices are child vertices of RE1 and should be processed after vertex RE1.

During the processing, information obtained from matching a parent vertex against a string is used to update the status of the child vertices. The parent match may, for example, provide information as to whether the match of the child vertex against the string is impossible, is certain, or is still possible. As an example, if a match of RE7 against a string produces CM=0, then the string cannot match RE5 or RE1, and those REs may be marked as impossible matches for the string. Similarly, if processing Re1 against a string yields CM=0 { [symbol] CM>0} then RE4, RE5, and RE2 may be marked as impossible. The result for RE5 follows, even though RE5 is not an immediate child of RE1, because edge 795 between RE4, a direct child of RE1, and RE5 is marked as transitive. Thus, information about the match of RE1 propagates across the two edges. If CM=1 {CM>0 & [symbol] CM>1} for a match between RE1 and a string, then RE2 is still impossible, but RE4 and RE5 are still possible. If CM>1, then RE2 is certain, and RE4 and RE5 are impossible. The above procedure may be generalized for parallel processing. In one example, a system may contain multiple threads or processing units each capable of running the Aho-Corasick algorithm. A priority work queue with for each processing unit may be created. An RE may be added to the queue when it is known that it needs to be processed. An RE needs to be processed until proven otherwise through the rules, by being proven to be a match or proven not to be a match. Threads or processing units may then select an RE from the front of the queue to process, first checking that the selected RE hasn't been marked as invalid or an exact match by another operation. In a refinement, the priority of an RE in the queue may be computed by the number of child relationships of the RE. In a further refinement, the type of child relationships may be considered. As an example, the priority of an RE may be judged by the number of child relationships where a match of the RE with a string indicates that a match with the child is possible, or may be judged by the number of child relationships where a match with the string indicates that a match with the child is not possible. In the later case, priority is assigned to REs in an attempt to maximize the number of child REs marked as impossible matches. In the case of parallel processing, it may be useful to process a parent RE with one processor while processing a child with another processor rather than let the other processor be idle.

In some embodiments, the processing of REs may be atomic, in the sense that the matching of an RE against a string is not halted to match a different RE against that string and then resumed. Further, each RE is represented by a separate DFA. In a contrasting approach, REs are divided into portions and the portions are combined to form a compound RE. This compound RE is matched against strings. The matching may be performed by constructing a single DFA representing the compound RE.

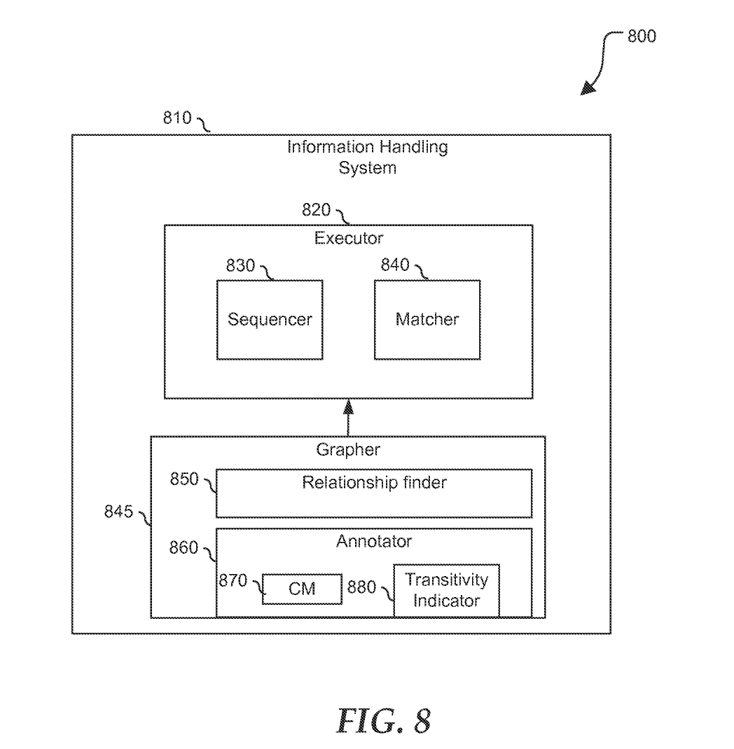

FIG. 8 illustrates an embodiment of information handling system 800 to place regular expressions in a graph annotated with information about matching strings. Information handling system 800 includes executor 820 and grapher 845. Grapher 845 includes relationship finder 850 and annotator 860. Grapher 845 may place regular expressions into a graph based upon parent/child relationships. Vertices of the graph may represent the regular expressions, and the edges may represent relationships between the vertices, such as parent/child relationships. Relationship finder 850 may determine the parent/child relationships used to form the graph Annotator 860 may annotate the edges in the graph with information about matching strings. Annotator 860 includes character match (CM) 870 and transitivity indicator 880. CM 870 may annotate an edge between a vertex representing a parent regular expression and a vertex representing a child regular expression to indicate the required number of characters explicitly specified in the parent regular expression that must be matched by a string in order for the string to be a possible match for the child regular expression. An annotation of an edge by transitivity indicator 880 may indicate whether the relationship represented by the edge is transitive or intransitive.

Executor 820 includes matcher 840 and sequencer 830. Executor 820 may determine an order for matching the regular expressions against a string and perform the matching. Sequencer 830 may determine the order in which the regular expressions are matched against the string. The order may be based upon the structure of the graph formed by grapher 845. Once a regular expression has been selected to be matched against the string, matcher 840 may perform the actual match.

Information handling system 800 may perform the methods of FIG. 1. In further embodiments, information handling system 800 may perform these methods in accordance with the methods of FIGS. 2-7. The elements of information handling system 800 may be configured as hardware, as software, or as a combination of hardware and software.

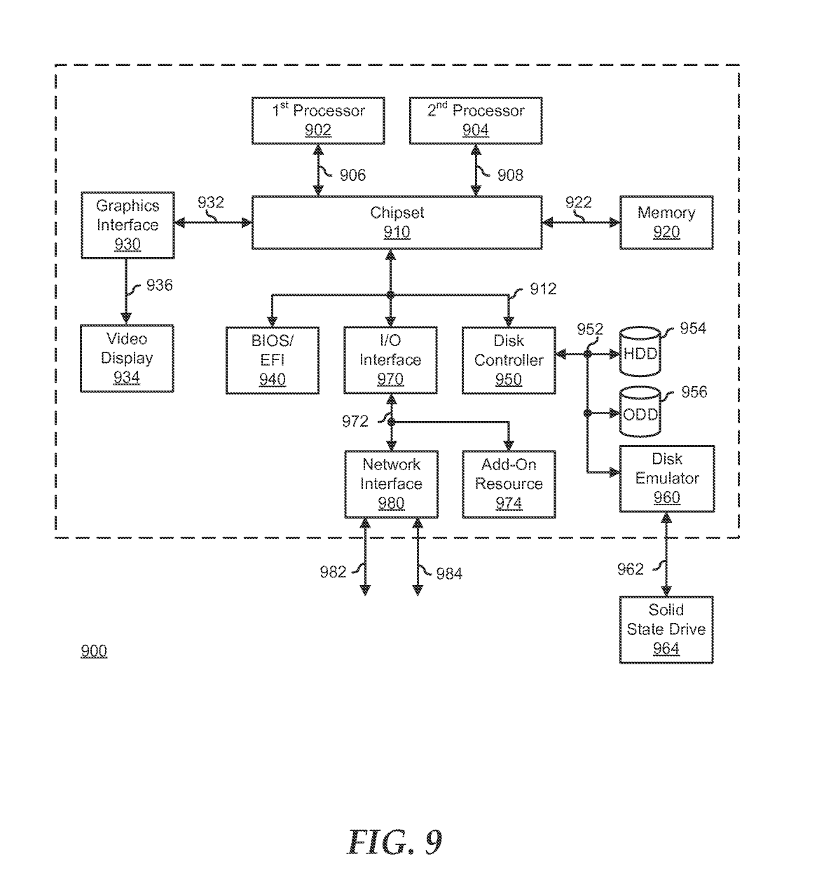

FIG. 9 illustrates a generalized embodiment of information handling system 900. For purpose of this disclosure information handling system 900 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 900 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 900 can include processing resources for executing machine-executable code, such as a central processing unit (CPU), a programmable logic array (PLA), an embedded device such as a System-on-a-Chip (SoC), or other control logic hardware. Information handling system 900 can also include one or more computer-readable medium for storing machine-executable code, such as software or data. Additional components of information handling system 900 can include one or more storage devices that can store machine-executable code, one or more communications ports for communicating with external devices, and various input and output (I/O) devices, such as a keyboard, a mouse, and a video display. Information handling system 900 can also include one or more buses operable to transmit information between the various hardware components.

Information handling system 900 can operate to match a set of regular expressions against a string according to embodiments of the present disclosure and to perform the functions of information handling system 800 according to embodiments of the present disclosure. Information handling system 900 includes processors 902 and 904, a chipset 910, a memory 920, a graphics interface 930, a basic input and output system/extensible firmware interface (BIOS/EFI) module 940, a disk controller 950, a disk emulator 960, an input/output (I/O) interface 970, and a network interface 980. Processor 902 is connected to chipset 910 via processor interface 906, and processor 904 is connected to chipset 910 via processor interface 908. Memory 920 is connected to chipset 910 via a memory bus 922. Graphics interface 930 is connected to chipset 910 via a graphics interface 932, and provides a video display output 936 to a video display 934. In a particular embodiment, information handling system 900 includes separate memories that are dedicated to each of processors 902 and 904 via separate memory interfaces. An example of memory 920 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 940, disk controller 950, and I/O interface 970 are connected to chipset 910 via an I/O channel 912. An example of I/O channel 912 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 910 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 940 includes BIOS/EFI code operable to detect resources within information handling system 900, to provide drivers for the resources, initialize the resources, and access the resources. BIOS/EFI module 940 includes code that operates to detect resources within information handling system 900, to provide drivers for the resources, to initialize the resources, and to access the resources.

Disk controller 950 includes a disk interface 952 that connects the disc controller to a hard disk drive (HDD) 954, to an optical disk drive (ODD) 956, and to disk emulator 960. An example of disk interface 952 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 960 permits a solid-state drive 964 to be connected to information handling system 900 via an external interface 962. An example of external interface 962 includes a USB interface, an IEEE 9194 (Firewire) interface, a proprietary interface, or a combination thereof. Alternatively, solid-state drive 964 can be disposed within information handling system 900.

I/O interface 970 includes a peripheral interface 972 that connects the I/O interface to an add-on resource 974 and to network interface 980. Peripheral interface 972 can be the same type of interface as I/O channel 912, or can be a different type of interface. As such, I/O interface 970 extends the capacity of I/O channel 912 when peripheral interface 972 and the I/O channel are of the same type, and the I/O interface translates information from a format suitable to the I/O channel to a format suitable to the peripheral channel 972 when they are of a different type. Add-on resource 974 can include a data storage system, an additional graphics interface, a network interface card (NIC), a sound/video processing card, another add-on resource, or a combination thereof. Add-on resource 974 can be on a main circuit board, on separate circuit board or add-in card disposed within information handling system 900, a device that is external to the information handling system, or a combination thereof.

Network interface 980 represents a NIC disposed within information handling system 900, on a main circuit board of the information handling system, integrated onto another component such as chipset 910, in another suitable location, or a combination thereof. Network interface device 980 includes network channels 982 and 984 that provide interfaces to devices that are external to information handling system 900. In a particular embodiment, network channels 982 and 984 are of a different type than peripheral channel 972 and network interface 980 translates information from a format suitable to the peripheral channel to a format suitable to external devices. An example of network channels 982 and 984 includes InfiniBand channels, Fibre Channel channels, Gigabit Ethernet channels, proprietary channel architectures, or a combination thereof. Network channels 982 and 984 can be connected to external network resources (not illustrated). The network resource can include another information handling system, a data storage system, another network, a grid management system, another suitable resource, or a combination thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
placing by an information handling system regular expressions into parent/child relationships wherein a first regular expression is set as a child of a second regular expression when information about matching the first regular expression against a first string is obtained by matching the second regular expression against the first string;
forming the regular expressions into a graph, the graph containing vertices representing the regular expressions and edges representing the parent/child relationships between the regular expressions; and
matching the regular expressions against a second string in an order based upon a structure of the graph, the order comprising matching a third regular expression against the second string before matching a fourth regular expression against the second string based upon a vertex representing the fourth regular expression being a child of a vertex representing the third regular expression.

2. The method of claim 1, wherein the first regular expression is set as the child of the second regular expression when a non-match between the second regular expression and the first string implies a non-match between the first regular expression and the first string.

3. The method of claim 2, wherein the first regular expression is set as the child of the second regular expression when:
the second regular expression is of the form .*<seq> . . . , where <seq> represents any sequence of characters of an alphabet and ‘ . . . ’ represents that the remainder of the expression may be of any form; and
the sequence <seq> is present in the first regular expression in one of the following ways:
<seq> is on a serial section of the first regular expression;
<seq> is on a cyclic, non-branched sequence of states of the first regular expression; or
<seq> is on all paths of a parallel divergence of the first regular expression.

4. The method of claim 2, wherein the first regular expression is set as the child of the second regular expression when:
the second regular expression is of the form ̂<seq1> . . . , where <seq1> represents any sequence of characters of an alphabet and ‘ . . . ’ represents that the remainder of the second regular expression may be of any form; and
the first regular expression is of the form ̂<seq2> . . . , where <seq2> represents any sequence of characters of an alphabet and ‘ . . . ’ represents that the remainder of the first regular expression may be of any form.

5. The method of claim 1, wherein the information includes a count of characters explicitly specified in the second regular expression that is matched by the first string.

6. The method of claim 5, further comprising annotating an edge of the edges between a second vertex representing the second regular expression and a first vertex representing the first regular expression with a required number of characters explicitly specified in the second regular expression that must be matched by the second string in order for the second string to be a possible match for the first regular expression.

7. The method of claim 1, further comprising annotating an edge of the edges between a second vertex representing the second regular expression and a first vertex representing the first regular expression with an indication of whether the parent/child relationship between the second regular expression and the first regular expression relationship is a transitive relationship.

8. The method of claim 1, further comprising matching a fifth regular expression against the second string before matching a sixth regular expression against the second string based upon the fifth regular expression having more children on the graph than the sixth regular expression.

9. The method of claim 4, further comprising matching the sixth regular expression against the second string before matching the second regular expression against the second string based upon the sixth regular expression being of the form ̂<seq1> . . . .

10. The method of claim 1, further comprising matching a fifth regular expression against the second string before matching a sixth regular expression against the second string based upon a match between the fifth regular expression and the second string implying a non-match between the second string and a child vertex of the fifth regular expression.

11. The method of claim 1, wherein the information handling system has a plurality of processors, the method further comprising:
creating a work queue for the regular expressions;
placing a subset of the regular expressions in the work queue when it is known that the subset needs to be processed;
ordering the subset of the regular expressions in the queue based upon the structure of the graph; and
selecting by one of the processors a regular expression of the subset of regular expressions from a front of the queue based upon the regular expression not having been marked as an invalid match or an exact match as a result of a previous matching operation.

12. A method comprising:
placing by an information handling system regular expressions into parent/child relationships wherein a first regular expression is set as a child of a second regular expression when information about matching the first regular expression against a first string is obtained by matching the second regular expression against the first string;
forming the regular expressions into a graph, the graph containing vertices representing the regular expressions and edges representing the parent/child relationships between the regular expressions; and
annotating the edges of the graph, wherein an annotation of an edge between a parent vertex representing a parent regular expression and a child vertex representing a child regular expression indicates information about the parent/child relationship, the information comprising a required number of characters explicitly specified in the parent regular expression that must be matched by a second string in order for the second string to be a possible match for the child regular expression.

13. The method of claim 12, further comprising recompiling the graph based upon an addition or deletion of a vertex representing a third regular expression, wherein:
in the case of addition of the vertex, the only addition of edges to the graph in the recompiling is an addition of edges to the vertex; and
in the case of deletion of the vertex, the only deletion of edges to the graph in the recompiling is a deletion of edges to the vertex.

14. The method of claim 12, further comprising annotating the edge between the parent vertex and the child vertex with an indication of whether the parent/child relationship between the parent regular expression and the child regular expression relationship is a transitive relationship.

15. The method of claim 12, further comprising matching the regular expressions against a second string in an order based upon a structure of the graph, the order comprising matching a third regular expression against the second string before matching a fourth regular expression against the second string based upon a vertex representing the fourth regular expression being a child of a vertex representing the third regular expression.

16. The method of claim 12, wherein the first regular expression is set as the child of the second regular expression when a non-match between the second regular expression and the first string implies a non-match between the first regular expression and the first string.

17. An information handling system comprising:
a relationship finder to place regular expressions into parent/child relationships wherein a first regular expression is set as a child of a second regular expression when information about matching the first regular expression against a first string is obtained by matching the second regular expression against the first string;
a grapher to form the regular expressions into a graph based upon the parent/child relationships, the graph containing vertices representing the regular expressions and edges representing relationships between the regular expressions; and
an annotator to annotate edges on the graph with information about the parent/child relationships, the annotations to include an annotation on an edge between a parent regular expression and a child regular expression to indicate a required number of characters explicitly specified in the parent regular expression that must be matched by a second string in order for the second string to be a possible match for the child regular expression.

18. The information handling system of claim 17, further comprising an executor to match the regular expressions against the second string in an order based upon a structure of the graph, the order comprising matching a third regular expression against the second string before matching a fourth regular expression against the second string based upon a vertex representing the fourth regular expression being a child of a vertex representing the third regular expression.

19. The information handling system of claim 17, wherein the relationship finder is to set the first regular expression as the child of the second regular expression when a non-match between the second regular expression and the first string implies a non-match between the first regular expression and the first string.

20. The information handling system of claim 17, wherein the annotator is to annotate the edges of the graph to indicate whether relationships represented by the edges are transitive relationships.
